(19) United States
(12) Patent Application Publication
(10) Pub. No.: US 2024/0348558 A1
(43) Pub. Date: Oct. 17, 2024

(54) SIGNAL TRANSFER SYSTEM, SIGNAL TRANSFER CONTROL APPARATUS, SIGNAL TRANSFER CONTROL METHOD AND PROGRAM

(71) Applicant: NIPPON TELEGRAPH AND TELEPHONE CORPORATION, Tokyo (JP)

(72) Inventors: Hiroko NOMURA, Musashino-shi (JP); Yoshihito SAKAI, Musashino-shi (JP)

(73) Assignee: NIPPON TELEGRAPH AND TELEPHONE CORPORATION, Tokyo (JP)

(21) Appl. No.: 18/701,040

(22) PCT Filed: Oct. 21, 2021
(86) PCT No.: PCT/JP2021/038945

§ 371 Date: Apr. 12, 2024

(51) Int. Cl. H04L 47/625; H04L 47/12

(52) U.S. Cl. CPC H04L 47/626; H04L 47/12

(57) ABSTRACT

A signal transfer system including a first signal transfer control device associated with a first network, and a second signal transfer control device associated with a second network connected to the first network via an intermediate node, in which the first signal transfer control device includes a first communication unit that transmits first schedule information at a predetermined notification cycle, and a second communication unit that transmits a trigger signal on the basis of a change amount of traffic of the first network, and the second signal transfer control device includes an acquisition unit that acquires the first schedule information at the predetermined notification cycle, a third communication unit that acquires the trigger signal, a change amount determination unit that, when the trigger signal is acquired, determines whether or not the change amount of traffic of the first network is equal to or greater than a threshold on the basis of the first schedule information, an information update unit that updates second schedule information when it is determined that the change amount is equal to or greater than the threshold, and a cycle instruction unit that instructs a predetermined notification cycle when it is determined that the change amount is equal to or greater than the threshold.

### TECHNICAL FIELD

The present invention relates to a signal transfer system, a signal transfer control apparatus, a signal transfer control method and a program.

### BACKGROUND ART

In the 5th generation mobile communication system (5G) and the like, there is known a signal transfer system including mobile fronthaul (MFH), mobile midhaul (MMH), and mobile backhaul (MBH) and configured to control traffic.

For example, there is a signal transfer system in which communication paths between a plurality of distributed units (DUs) to which a plurality of radio units (RUs) is connected, respectively, and a plurality of central units (CUs) are switched by a switch (SW).

In a signal transfer system that sequentially transfers signals, packets are generally delayed when passing through the switch. Therefore, various techniques are applied to achieve a low latency network.

For example, a time aware shaper (TAS) technique is known as one of techniques for reducing a delay of high-priority signals. In the TAS, strict priority queuing is performed, and the transmission time slot is reserved (open gate and close gate with other priority) in the signal transfer device for the periodically transmitted signal of the priority to be subjected to priority queuing. In a priority transmission section, signals having other priorities cannot be transmitted (are kept waiting). In strict priority queuing, the signal transfer device receives a signal to be subjected to priority queuing and opens a corresponding time gate when transmission of a currently transmitted signal ends after the signal is transmittable (see Patent Document 1).

Non Patent Document 1 defines bridges and LANs for networks required to have low latency.

### CITATION LIST

### Patent Document

Patent Document 1: JP 2020-92317 A

### Non Patent Document

Non Patent Document 1: “IEEE Standard for Local and metropolitan area networks-Time-Sensitive Networking for Fronthaul”, IEEE Std 802.1CM, May 7, 2018

### SUMMARY OF INVENTION

### Technical Problem

However, conventionally, for example, in a case where a signal is transferred from a network that transfers a signal by TAS to another network that transfers a signal by TAS via an intermediate node, schedule information cannot be coordinated. In such a network, latency in the intermediate node is not considered.

For example, the reservation of the time slot needs to include a certain fixed time when processing time in the intermediate node is set. The fixed time is an estimated value. Therefore, in order to cause traffic to arrive within the time slot, it is necessary to add a margin to a reservation time, and bandwidth utilization efficiency is reduced in some cases.

The present invention has been made in view of the above problems, and an object thereof is to provide a signal transfer system, a signal transfer control device, a signal transfer control method, and a program capable of improving bandwidth utilization efficiency even in a case where a signal is transferred across a plurality of different networks that transfers signals.

### Solution to Problem

One aspect of the present invention is a signal transfer system including a first signal transfer control device associated with a first network, and a second signal transfer control device associated with a second network connected to the first network via an intermediate node, in which the first signal transfer control device includes a first communication unit that transmits first schedule information indicating a schedule of signal transfer in the first network at a predetermined notification cycle, and a second communication unit that transmits a trigger signal on the basis of a change amount of traffic of the first network, and the second signal transfer control device includes an acquisition unit that acquires the first schedule information at the predetermined notification cycle, a third communication unit that acquires the trigger signal from the second communication unit, a change amount determination unit that, when the trigger signal is acquired, determines whether or not the change amount of traffic of the first network is equal to or greater than a threshold on the basis of the first schedule information, an information update unit that updates second schedule information indicating a schedule of signal transfer in the second network when it is determined that the change amount is equal to or greater than the threshold, and a cycle instruction unit that instructs the first signal transfer control device to set the predetermined notification cycle when it is determined that the change amount is equal to or greater than the threshold.

One aspect of the present invention is a signal transfer control device including: an acquisition unit that acquires first schedule information indicating a schedule of signal transfer in a first network from another signal transfer control device associated with the first network at a predetermined notification cycle; a communication unit that acquires a trigger signal based on a change amount of traffic of the first network from the other signal transfer control device; a change amount determination unit that, when the trigger signal is acquired, determines whether or not the change amount of traffic of the first network is equal to or greater than a threshold on the basis of the first schedule information; an information update unit that updates second schedule information indicating a schedule of signal transfer in a second network connected to the first network via an intermediate node when it is determined that the change amount is equal to or greater than the threshold; and a cycle instruction unit that instructs the other signal transfer control device to set the predetermined notification cycle when it is determined that the change amount is equal to or greater than the threshold.

One aspect of the present invention is a signal transfer control method executed by a signal transfer control device, the method including: an acquisition step of acquiring first schedule information indicating a schedule of signal transfer in a first network from another signal transfer control device associated with the first network at a predetermined notification cycle; a communication step of acquiring a trigger signal based on a change amount of traffic of the first network from the other signal transfer control device; a change amount determination step of, when the trigger signal is acquired, determining whether or not the change amount of traffic of the first network is equal to or greater than a threshold on the basis of the first schedule information; an information update step of updating second schedule information indicating a schedule of signal transfer in a second network connected to the first network via an intermediate node when it is determined that the change amount is equal to or greater than the threshold; and a cycle instruction step of instructing the other signal transfer control device to set the predetermined notification cycle when it is determined that the change amount is equal to or greater than the threshold.

One aspect of the present invention is a program for causing a computer to function as the above-described signal transfer control device.

### Advantageous Effects of Invention

The present invention can improve bandwidth utilization efficiency even in a case where a signal is transferred across a plurality of different networks that transfers signals.

### BRIEF DESCRIPTION OF DRAWINGS

FIG. 1 illustrates a configuration example of a signal transfer system according to a first embodiment.

FIG. 2 illustrates a configuration example of a signal transfer control device according to the first embodiment.

FIG. 3 illustrates second schedule information determined by a determination unit according to the first embodiment.

FIG. 4 schematically illustrates a process in which a signal transfer control device according to the first embodiment determines second schedule information.

FIG. 5 illustrates a configuration example of a signal transfer control device according to a second embodiment.

FIG. 6 illustrates a configuration example of a signal transfer control device according to a third embodiment.

FIG. 7 is a sequence diagram of an operation example of the signal transfer control device according to the third embodiment.

FIG. 8 illustrates a hardware configuration example of the signal transfer control device according to the embodiments.

FIG. 9 illustrates a configuration example of a signal transfer system according to a comparative example.

FIG. 10 illustrates a configuration example of a signal transfer device.

FIG. 11 illustrates a configuration example of a signal transfer control device.

### DESCRIPTION OF EMBODIMENTS

First, a signal transfer system of an example for comparing with a signal transfer system of each embodiment will be described.

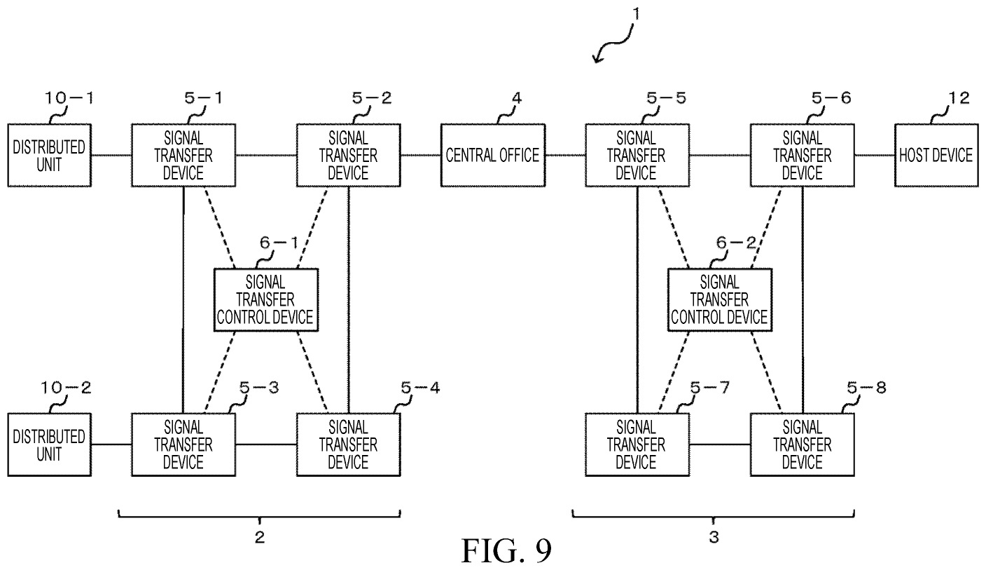

FIG. 9 illustrates a configuration example of a signal transfer system 1 according to a comparative example. In the signal transfer system 1, for example, a first network 2 and a second network 3 are connected via a central office 4. The signal transfer system 1 transfers signals (traffic) such that distributed units (lower devices) 10-1 and 10-2 perform bidirectional communication with a host device 12 via the first network 2, the central office 4, and the second network 3. The distributed units 10-1 and 10-2 (or the host device 12) are devices that generate traffic.

The first network 2 includes, for example, signal transfer devices 5-1 to 5-4 and a signal transfer control device 6-1. The signal transfer devices 5-1 to 5-4 form a plurality of paths for transferring signals between the distributed units 10-1 and 10-2 and the central office 4.

The signal transfer devices 5-1 to 5-4 transfer signals transmitted by the distributed units 10-1 and 10-2 to the central office 4 by TAS under the control of the signal transfer control device 6-1. The signal transfer devices 5-1 to 5-4 also transfer signals transmitted by the central office 4 to the distributed units 10-1 and 10-2 by TAS under the control of the signal transfer control device 6-1.

The signal transfer control device 6-1 determines a path for transferring signals between the distributed units 10-1 and 10-2 and the central office 4, outputs a command so as to transfer the signals through the determined path, and controls the signal transfer devices 5-1 to 5-4.

The second network 3 includes, for example, signal transfer devices 5-5 to 5-8 and a signal transfer control device 6-2. The signal transfer devices 5-5 to 5-8 form a plurality of paths for transferring signals between the central office 4 and the host device 12.

The signal transfer devices 5-5 to 5-8 transfer signals transmitted by the central office 4 to the host device 12 by TAS under the control of the signal transfer control device 6-2. The signal transfer devices 5-5 to 5-8 also transfer signals transmitted by the host device 12 to the central office 4 by TAS under the control of the signal transfer control device 6-2.

The signal transfer control device 6-2 determines a path for transferring signals between the central office 4 and the host device 12, outputs a command so as to transfer the signals through the determined path, and controls the signal transfer devices 5-5 to 5-8.

The central office 4 is, for example, a central unit (CU) and serves as an intermediate node that transfers signals from the first network 2 to the second network 3 or from the second network 3 to the first network 2. That is, the central office 4 aggregates uplink signals transferred via the first network 2 to transfer the uplink signals to the second network 3 and distributes downlink signals transferred via the second network 3 to transfer the downlink signals to the first network 2.

Hereinafter, in a case where no single component is specified among a plurality of components, such as the signal transfer devices 5-1 to 5-8, the component is simply abbreviated as, for example, the signal transfer device 5.

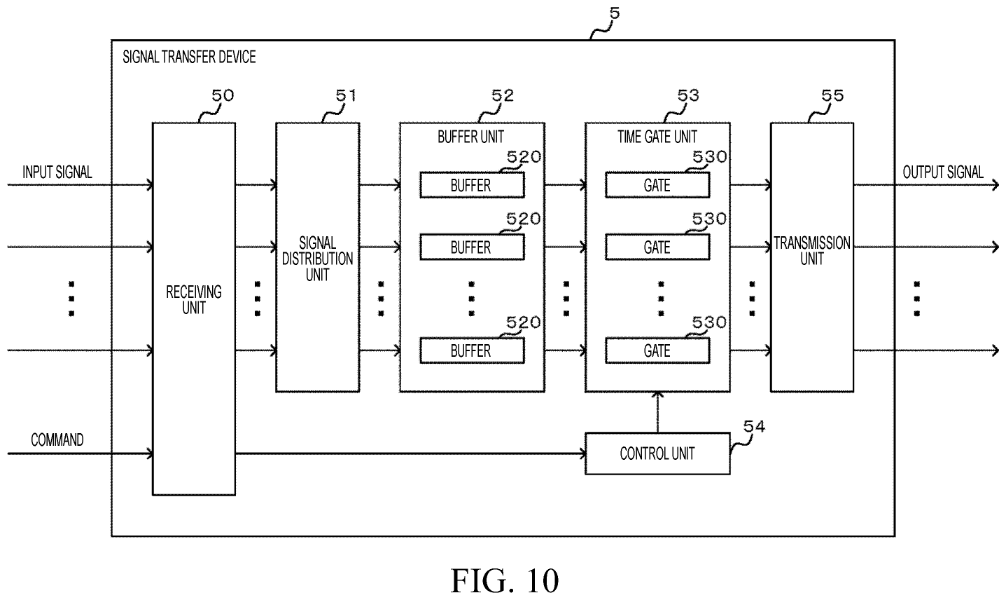

FIG. 10 illustrates a configuration example of the signal transfer device 5. As illustrated in FIG. 10, the signal transfer device 5 includes, for example, a receiving unit 50, a signal distribution unit 51, a buffer unit 52, a time gate unit 53, a control unit 54, and a transmission unit 55 and transfers received signals by TAS.

The receiving unit 50 receives, for example, a plurality of signals including periodic signals having a higher priority than other signals and outputs the received signals to the signal distribution unit 51. The receiving unit 50 also receives a command output from the signal transfer control device 6 and outputs the command to the control unit 54.

The signal distribution unit 51 has a function of distributing the signals input from the receiving unit 50 according to the priority and outputs the signals distributed according to the priority to the buffer unit 52.

The buffer unit 52 includes a plurality of buffers 520 that holds signals according to the priority. The plurality of buffers 520 holds the signals, respectively, distributed by the signal distribution unit 51 according to the priority. That is, the plurality of buffers 520 holds the plurality of signals, respectively, received by the receiving unit 50 according to the priority.

The time gate unit 53 includes a plurality of gates 530 corresponding to the plurality of buffers 520. The gate 530 transmits the signal held by the buffer 520 to the transmission unit 55 when the gate opens and stops transmitting the signal held by the buffer 520 to the transmission unit 55 when the gate is closed.

The control unit 54 is a scheduler that controls signal transmission of each buffer 520 by controlling opening and closing of each of the plurality of gates 530 included in the time gate unit 53 in response to, for example, a command (schedule information) issued from the signal transfer control device 6. The schedule information includes a gate open period and a gate open start time according to the priority of a signal by TAS.

For example, the control unit 54 performs TAS according to the schedule information issued from the signal transfer control device 6. At this time, the control unit 54 performs control so as to open the gate 530 at a timing determined on the basis of period information, phase information, and a data length of the signal included in the schedule information. For example, the control unit 54 performs control so as to prioritize the buffer 520 holding a signal having a high priority and open the corresponding gate 530.

The transmission unit 55 has a transfer function of transmitting the signal at the opened gate 530 to a designated output destination. That is, the transmission unit 55 transmits the signals output from the plurality of buffers 520 under the control of the control unit 54.

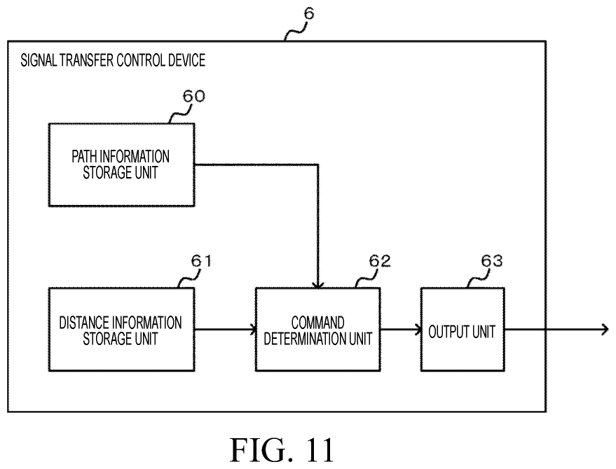

FIG. 11 illustrates a configuration example of the signal transfer control device 6. As illustrated in FIG. 11, the signal transfer control device 6 includes, for example, a path information storage unit 60, a distance information storage unit 61, a command determination unit 62, and an output unit 63.

The path information storage unit 60 stores, for example, path information indicating a plurality of paths configured by the plurality of signal transfer devices 5 and outputs the path information to the command determination unit 62 in response to access from the command determination unit 62.

The distance information storage unit 61 stores, for example, distance information indicating a distance of each path indicated by the path information stored in the path information storage unit 60 and outputs the distance information to the command determination unit 62 in response to access from the command determination unit 62.

The command determination unit 62 determines a command (schedule information) for each of the plurality of signal transfer devices 5 on the basis of the path information and the distance information and outputs the determined command to the output unit 63.

The output unit 63 outputs (transmits) the command output by the command determination unit 62 to each of the plurality of signal transfer devices 5.

Next, an operation example of the signal transfer system 1 (FIG. 9) will be described. In a case where a signal is transferred from the distributed unit 10-1 or 10-2 to the host device 12, the first network 2 determines a path via the plurality of signal transfer devices 5 under the control of the signal transfer control device 6-1 and transfers the signal transmitted from the distributed unit 10-1 or 10-2 to the central office 4 through the determined path by TAS.

The central office 4 processes the signal transferred by the first network 2 and transfers the signal to the second network 3. The second network 3 determines a path passing through the plurality of signal transfer devices 5 under the control of the signal transfer control device 6-2 and transfers the signal transferred by the central office 4 to the host device 12 through the determined path by TAS.

As described above, in the signal transfer across the central office 4 in the signal transfer system 1, schedule information of the first network 2 and schedule information of the second network 3 are not coordinated with each other.

That is, reservation of a time slot in the second network 3 needs to include a certain fixed time when processing time by the central office 4 is set. The fixed time is an estimated value. Therefore, in order to cause traffic to arrive within the time slot, it is necessary to add a margin to a reservation time, and bandwidth utilization efficiency is reduced in some cases.

In view of this, a signal transfer system according to an embodiment described below is configured to improve bandwidth utilization efficiency even in a case where a signal is transferred across a plurality of different networks that transfers signals by TAS.

### First Embodiment

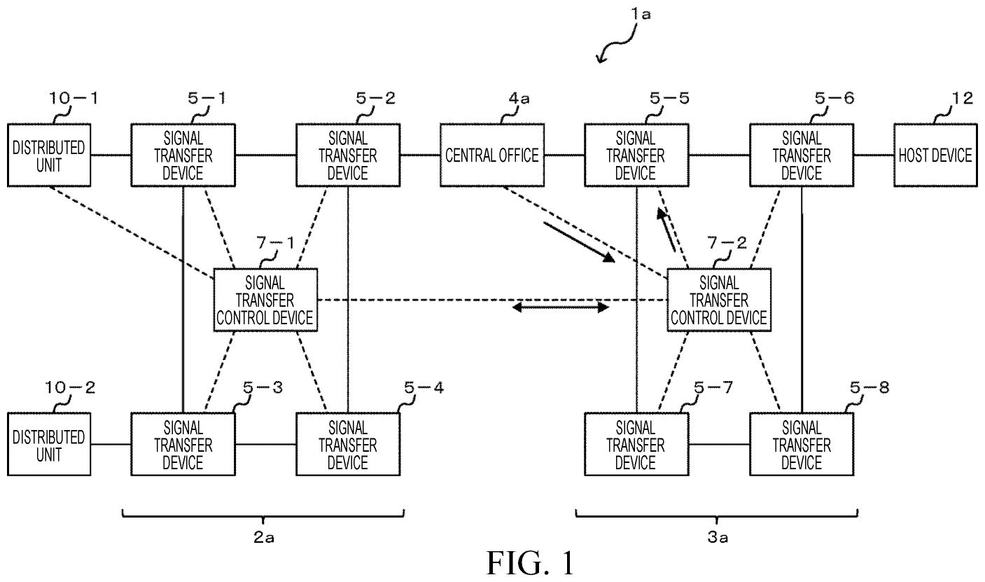

FIG. 1 illustrates a configuration example of a signal transfer system 1a according to a first embodiment. In the signal transfer system 1a, for example, a first network 2a and a second network 3a are connected via a central office 4a. The signal transfer system Ta transfers signals (traffic) such that distributed units (lower devices) 10-1 and 10-2 perform bidirectional communication with a host device 12 via the first network 2a, the central office 4a, and the second network 3a.

Hereinafter, in the signal transfer system 1a of FIG. 1, substantially the same components as those of the signal transfer system 1 of FIG. 9 will be denoted by the same reference signs.

The first network 2a includes, for example, signal transfer devices 5-1 to 5-4 and a signal transfer control device 7-1. The signal transfer devices 5-1 to 5-4 form a plurality of paths for transferring signals between the distributed units 10-1 and 10-2 and the central office 4a.

The signal transfer devices 5-1 to 5-4 transfer signals transmitted by the distributed units 10-1 and 10-2 to the central office 4a by TAS under the control of the signal transfer control device 7-1. The signal transfer devices 5-1 to 5-4 also transfer signals transmitted by the central office 4a to the distributed units 10-1 and 10-2 by TAS under the control of the signal transfer control device 7-1.

The signal transfer control device 7-1 determines a path for transferring signals between the distributed units 10-1 and 10-2 and the central office 4a, outputs a command so as to transfer the signals through the determined path, and controls the signal transfer devices 5-1 to 5-4. The signal transfer control device 7-1 transmits schedule information in the first network 2a to a signal transfer control device 7-2. Further, the signal transfer control device 7-1 has a function of acquiring processing time information (described later) from the central office 4a.

The second network 3a includes, for example, signal transfer devices 5-5 to 5-8 and the signal transfer control device 7-2. The signal transfer devices 5-5 to 5-8 form a plurality of paths for transferring signals between the central office 4a and the host device 12.

The signal transfer devices 5-5 to 5-8 transfer signals transmitted by the central office 4a to the host device 12 by TAS under the control of the signal transfer control device 7-2. The signal transfer devices 5-5 to 5-8 also transfer signals transmitted by the host device 12 to the central office 4a by TAS under the control of the signal transfer control device 7-2.

The signal transfer control device 7-2 determines a path for transferring signals between the central office 4a and the host device 12, outputs a command so as to transfer the signals through the determined path, and controls the signal transfer devices 5-5 to 5-8. The signal transfer control device 7-2 transmits schedule information in the second network 3a to the signal transfer control device 7-1. Further, the signal transfer control device 7-2 has a function of acquiring processing time information (described later) from the central office 4a.

The central office 4a is, for example, a central unit (CU) and serves as an intermediate node that transfers signals from the first network 2a to the second network 3a or from the second network 3a to the first network 2a. That is, the central office 4a aggregates uplink signals transferred via the first network 2a to transfer the uplink signals to the second network 3a and distributes downlink signals transferred via the second network 3a to transfer the downlink signals to the first network 2a.

As described above, the signal transfer system 1a transfers signals such that the distributed units 10-1 and 10-2 and the host device 12 can perform bidirectional communication. Here, an example where the signal transfer system 1a transfers an uplink signal will be described.

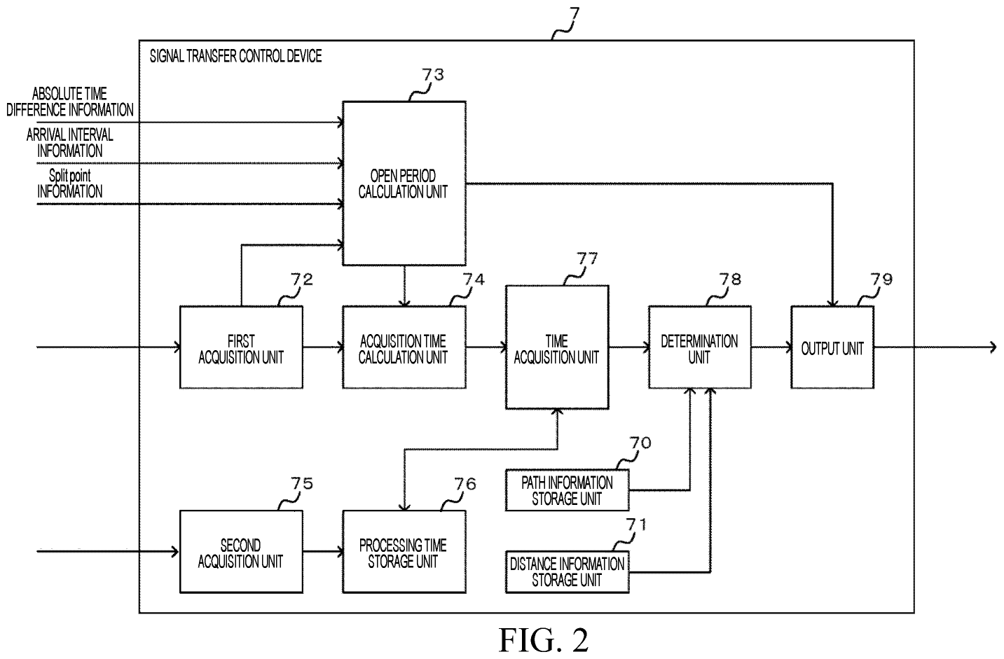

FIG. 2 illustrates a configuration example of the signal transfer control device 7-2 according to the first embodiment. As illustrated in FIG. 2, the signal transfer control device 7-2 includes, for example, a path information storage unit 70, a distance information storage unit 71, a first acquisition unit 72, an open period calculation unit 73, an acquisition time calculation unit 74, a second acquisition unit 75, a processing time storage unit 76, a time acquisition unit 77, a determination unit 78, and an output unit 79. For example, the signal transfer control device 7-2 controls a signal transfer schedule for transferring a signal from the central office 4a to the second network 3a. Note that the signal transfer control device 7-1 also has the same configuration as the signal transfer control device 7-2.

The path information storage unit 70 stores, for example, path information indicating a plurality of paths configured by the plurality of signal transfer devices 5 and outputs the path information to the determination unit 78 in response to access from the determination unit 78.

The distance information storage unit 71 stores, for example, distance information indicating a distance of each path indicated by the path information stored in the path information storage unit 70 and outputs the distance information to the determination unit 78 in response to access from the determination unit 78.

The first acquisition unit 72 acquires first schedule information from, for example, the signal transfer control device 7-1. The first schedule information indicates a schedule in which the signal transfer device 5-2 that finally transfers a signal to the central office 4a in the first network 2a transfers a signal by TAS. Then, the first acquisition unit 72 outputs the acquired first schedule information to the open period calculation unit 73 and the acquisition time calculation unit 74.

The first acquisition unit 72 may acquire the first schedule information at a predetermined periodic first timing.

The open period calculation unit 73 acquires function split point information between the central office 4a and the host device 12 in the second network 3a. The open period calculation unit 73 further acquires absolute time difference information indicating a difference between a time in the first network 2a and a time in the second network 3a. The open period calculation unit 73 further acquires arrival interval information indicating a time interval at which processing time information arrives, the processing time information indicating a time required for processing performed by the central office 4a to transfer the signal to the second network 3a. The open period calculation unit 73 further acquires the first schedule information from the first acquisition unit 72.

Then, the open period calculation unit 73 calculates an available bandwidth in the second network 3a on the basis of each piece of the acquired information, calculates a gate open period of each signal transfer device 5, and outputs, for example, the acquired information and the calculation result to the acquisition time calculation unit 74 and the output unit 79.

The acquisition time calculation unit 74 calculates an offset value necessary for setting schedule information (gate open period and gate open start time) to the signal transfer device 5-5 that first transfers a signal in the second network 3a and outputs arrival interval (acquisition timing) information at an absolute time and the offset value to the time acquisition unit 77.

The second acquisition unit 75 acquires, from the central office 4a, processing time information tβ(t) indicating a time required for processing performed by the central office 4a to transfer the signal transferred from the first network 2a to the second network 3a. Then, the second acquisition unit 75 outputs the acquired processing time information and the information indicating the interval at which the processing time information arrives from the central office 4a (transmission timing from central office 4a) to the processing time storage unit 76.

The second acquisition unit 75 may acquire the processing time information at a predetermined periodic second timing different from the first timing of the first acquisition unit 72.

The processing time storage unit 76 stores the processing time information tβ(t) input from the second acquisition unit 75 and the information indicating the transmission timing from the central office 4a and outputs the information in response to access from the time acquisition unit 77.

The time acquisition unit 77 outputs the information (offset value and acquisition timing) input from the acquisition time calculation unit 74 and the information (processing time information and information indicating transmission timing from central office 4a) acquired from the processing time storage unit 76 to the determination unit 78 in association with each other.

The determination unit 78 determines second schedule information indicating a schedule in which the signal transfer device 5-5 that first transfers a signal transferred by the central office 4a in the second network 3a is to transfer the signal by TAS on the basis of each piece of the information input from the path information storage unit 70, the distance information storage unit 71, and the time acquisition unit 77 and outputs the second schedule information to the output unit 79.

For example, in a case where a gate open time in the signal transfer device 5-2 is T1, the determination unit 78 sets the gate open time of the signal transfer device 5-5 to T1+D+tβ(t). Note that D denotes a transmission time between the signal transfer device 5-2 and the signal transfer device 5-5. The determination unit 78 determines the second schedule information on the basis of a bandwidth in which a signal in the second network 3a is transferable.

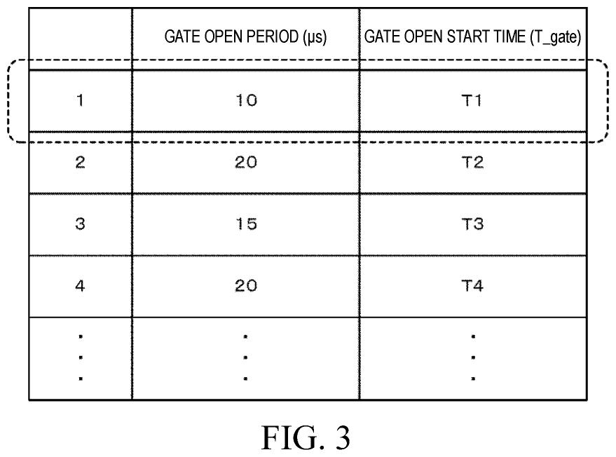

FIG. 3 illustrates the second schedule information determined by the determination unit 78. As illustrated in FIG. 3, the determination unit 78 determines the gate open period and the gate open start time as the second schedule information.

That is, the determination unit 78 determines a schedule (second schedule information) in which the signal transfer device 5-5 is to transfer the signal transferred by the central office 4a by TAS on the basis of the first schedule information acquired by the first acquisition unit 72 and the processing time information acquired by the second acquisition unit 75. At this time, the determination unit 78 determines the second schedule information by synchronizing a time between the first network 2a and the second network 3a.

The determination unit 78 may determine the second schedule information on the basis of a result of determining whether or not a time between a time at which the first acquisition unit 72 acquires the first schedule information and a time at which the second acquisition unit 75 acquires the processing time information is longer than a time indicated by the processing time information acquired by the second acquisition unit 75.

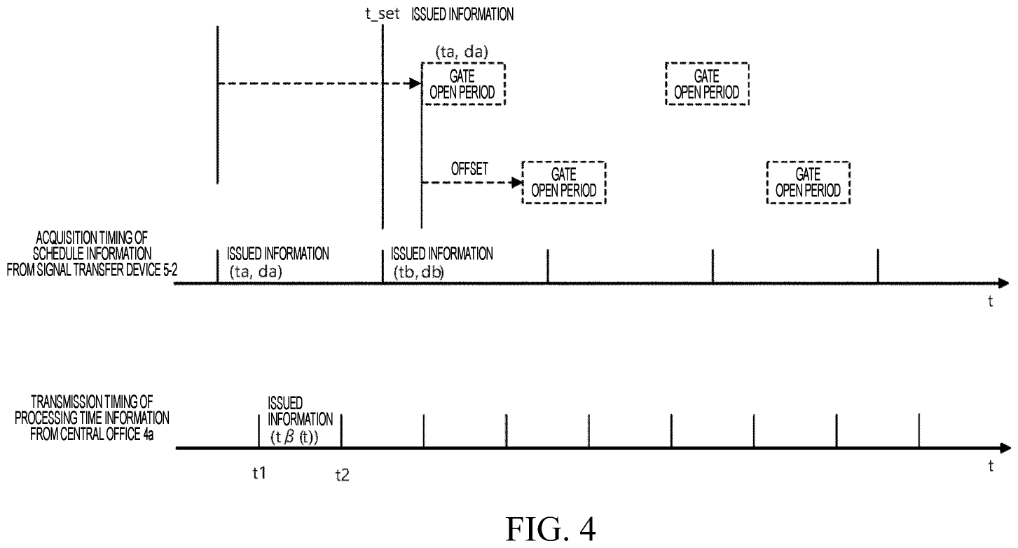

FIG. 4 schematically illustrates a process in which the signal transfer control device 7-2 determines the second schedule information. The signal transfer control device 7-2 outputs the second schedule information (gate open start time and gate open period) to the signal transfer device 5-5.

In order to synchronize the time between the first network 2a and the second network 3a, the signal transfer control device 7-2 sets an offset based on the difference between absolute times thereof, the path information, the distance information, and the processing time of the central office 4a.

At this time, a timing at which the signal transfer device 5-2 acquires the schedule information is shifted from a timing at which the central office 4a transmits the processing time information. Therefore, the signal transfer control device 7-2 corrects a timing shift in order to determine the gate open start time. For example, the signal transfer control device 7-2 performs correction by using the latest processing time of the central office 4a, an average value of the processing time, or the like.

The signal transfer control device 7-2 acquires split point information of MFH or MBH and determines the gate open period.

For example, the signal transfer control device 7-2 determines the second schedule information by using the processing time of the central office 4a closest to a schedule timing of the signal transfer device 5-5. For example, the signal transfer control device 7-2 acquires an interval at which the processing time information arrives from the central office 4a (transmission timing from central office 4a) in advance.

Then, in a case where the issued processing time is used as the offset, the signal transfer control device 7-2 sets the processing time as follows, for example.

When t_set−t2 >processing time: the processing time issued at t2 is set.

When t_set−t2≤processing time: the processing time issued at t1 is set.

Then, the output unit 79 (FIG. 2) outputs the second schedule information determined by the determination unit 78 to the signal transfer device 5-5 that first transfers the signal transferred by the central office 4a in the second network 3a.

For example, the output unit 79 issues the gate open period and the gate open start time surrounded by a broken line in FIG. 3 as a command to the signal transfer device 5-5 that first transfers the signal transferred by the central office 4a in the second network 3a.

As described above, in the signal transfer system 1a, the central office 4a issues the processing time information tβ(t) to the signal transfer control device 7-2, and the signal transfer control device 7-2 determines the second schedule information and issues the second schedule information to the control unit 54 of the signal transfer device 5.

Therefore, the signal transfer system 1a according to the first embodiment can improve bandwidth utilization efficiency even in a case where a signal is transferred across a plurality of different networks that transfers signals.

### Second Embodiment

The second embodiment is different from the first embodiment in that a signal transfer control device includes a correlation calculation unit and a prediction unit. In the second embodiment, the differences from the first embodiment are mainly described.

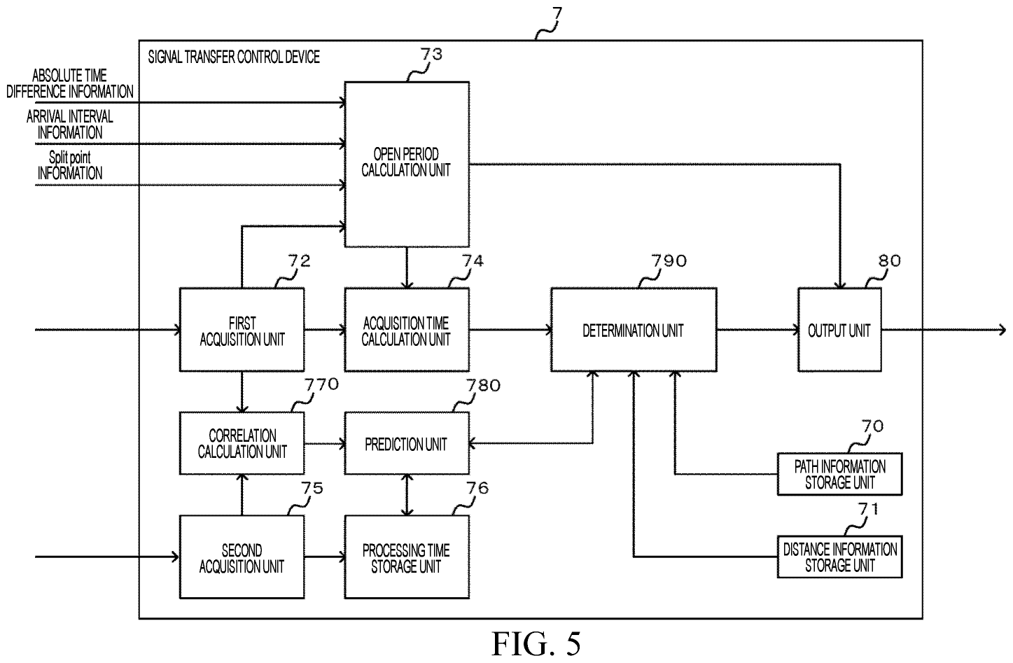

FIG. 5 illustrates a configuration example of a signal transfer control device 7-2 according to a second embodiment. As illustrated in FIG. 5, the signal transfer control device 7-2 includes, for example, a path information storage unit 70, a distance information storage unit 71, a first acquisition unit 72, an open period calculation unit 73, an acquisition time calculation unit 74, a second acquisition unit 75, a processing time storage unit 76, a correlation calculation unit 770, a prediction unit 780, a determination unit 790, and an output unit 80.

The signal transfer control device 7-2 controls a signal transfer schedule for transferring a signal from the central office 4a to the second network 3a. Note that the signal transfer control device 7-1 also has the same configuration as the signal transfer control device 7-2.

The path information storage unit 70 stores, for example, path information indicating a plurality of paths configured by the plurality of signal transfer devices 5 and outputs the path information to the determination unit 790 in response to access from the determination unit 790.

The distance information storage unit 71 stores, for example, distance information indicating a distance of each path indicated by the path information stored in the path information storage unit 70 and outputs the distance information to the determination unit 790 in response to access from the determination unit 790.

The first acquisition unit 72 acquires first schedule information from, for example, the signal transfer control device 7-1. The first schedule information indicates a schedule in which the signal transfer device 5-2 that finally transfers a signal to the central office 4a in the first network 2a transfers a signal by TAS. Then, the first acquisition unit 72 outputs the acquired first schedule information to the open period calculation unit 73 and the acquisition time calculation unit 74.

The first acquisition unit 72 may acquire the first schedule information at a predetermined periodic first timing.

The open period calculation unit 73 acquires function split point information between the central office 4a and the host device 12 in the second network 3a. The open period calculation unit 73 further acquires absolute time difference information indicating a difference between a time in the first network 2a and a time in the second network 3a. The open period calculation unit 73 further acquires arrival interval information indicating a time interval at which processing time information arrives, the processing time information indicating a time required for processing performed by the central office 4a to transfer the signal to the second network 3a. The open period calculation unit 73 further acquires the first schedule information from the first acquisition unit 72.

Then, the open period calculation unit 73 calculates an available bandwidth in the second network 3a on the basis of each piece of the acquired information, calculates a gate open period of each signal transfer device 5, and outputs, for example, the acquired information and the calculation result to the acquisition time calculation unit 74 and the output unit 80.

The acquisition time calculation unit 74 calculates an offset value necessary for setting schedule information (gate open period and gate open start time) to the signal transfer device 5-5 that first transfers a signal in the second network 3a and outputs arrival interval (acquisition timing) information at an absolute time, the first schedule information, and the offset value to the determination unit 790.

For each signal transferred from the first network 2a, the second acquisition unit 75 acquires, from the central office 4a, processing time information tβ(t) indicating a time required for processing performed by the central office 4a to transfer the signal to the second network 3a. Then, the second acquisition unit 75 outputs the acquired processing time information and the information indicating the interval at which the processing time information arrives from the central office 4a (transmission timing from central office 4a) to the processing time storage unit 76 and the correlation calculation unit 770.

The second acquisition unit 75 may acquire the processing time information at a predetermined periodic second timing different from the first timing of the first acquisition unit 72.

The processing time storage unit 76 stores the processing time information tβ(t) input from the second acquisition unit 75 and the information indicating the transmission timing from the central office 4a and outputs the information in response to access from the prediction unit 780.

The correlation calculation unit 770 calculates a correlation between a traffic volume flowing into the central office 4a and a time required for signal transfer processing on the basis of the first schedule information acquired by the first acquisition unit 72 and the plurality of pieces of the processing time information tβ(t) acquired for each signal by the second acquisition unit 75. Then, the correlation calculation unit 770 outputs information indicating the calculated correlation to the prediction unit 780.

The prediction unit 780 predicts a time (predicted processing time: predicted processing delay amount) required for signal transfer according to the traffic volume in the central office 4a on the basis of the correlation calculated by the correlation calculation unit 770 and the processing time information acquired for each signal by the second acquisition unit 75.

For example, the prediction unit 780 may predict the predicted processing time by linearly approximating a traffic volume d to a value indicated by the processing time information tβ(t) on the basis of the first schedule information and a plurality of pieces of processing time information stored in the processing time storage unit 76. This is because the processing time in the central office 4a increases according to the traffic volume flowing into the central office 4a. Then, the prediction unit 780 outputs information indicating the predicted time to the determination unit 790.

The determination unit 790 determines second schedule information indicating a schedule in which the signal transfer device 5-5 that first transfers a signal transferred by the central office 4a in the second network 3a is to transfer the signal by TAS on the basis of each piece of the information input from the path information storage unit 70, the distance information storage unit 71, the acquisition time calculation unit 74, and the prediction unit 780 and outputs the second schedule information to the output unit 80.

For example, in a case where the gate open time in the signal transfer device 5-2 is T1, the determination unit 790 may set the gate open time of the signal transfer device 5-5 to T1+D+tβ(t). Note that D denotes a transmission time between the signal transfer device 5-2 and the signal transfer device 5-5. The determination unit 790 determines the second schedule information on the basis of a bandwidth in which a signal in the second network 3a is transferable.

As described above, in the signal transfer system 1a, the central office 4a issues the processing time information tβ(t) to the signal transfer control device 7-2, and the signal transfer control device 7-2 determines the second schedule information on the basis of the first schedule information and the predicted processing time and issues the second schedule information to the control unit 54 of the signal transfer device 5.

Therefore, the signal transfer system 1a according to the second embodiment can improve bandwidth utilization efficiency even in a case where a signal is transferred across a plurality of different networks that transfers signals.

In the signal transfer system 1a, the signal transfer control device 7-2 predicts the predicted processing time according to the traffic volume of the central office 4a and determines the second schedule information. Thus, a processing load of the signal transfer control device 7-2 is reduced, as compared with a case where the processing time in the central office 4a is acquired for each packet to determine the second schedule information.

### Third Embodiment

In the first embodiment and the second embodiment, in the signal transfer system 1a in which the networks of the signal transfer devices 5 (for example, Layer 2 switches) connected via the central office 4a cooperate, a scheduler of the signal transfer control device 7-2 (N node) may be notified of the schedule information of the signal transfer control device 7-1 (“N−1” (“N” is an integer of 2 or more) node) and the processing time of the central office 4a (intermediate node) “packet by packet”.

In this case, for example, the processing load of the signal transfer control device 7-2 (the load of the reception processing of the information transmitted from the signal transfer control device 7-1 to the signal transfer control device 7-2) and the load of the calculation processing (derivation processing) in the signal transfer control device 7-1 increase. As described above, since each signal transfer control device 7 is required to have highly functional processing capability, there is a possibility that the cost of each signal transfer control device 7 increases.

Therefore, in the third embodiment, a signal transfer control device 7 capable of curbing an increase in the load of at least one of the reception processing and the calculation processing in a signal transfer control device 7 will be described focusing on a difference from the first embodiment and the second embodiment.

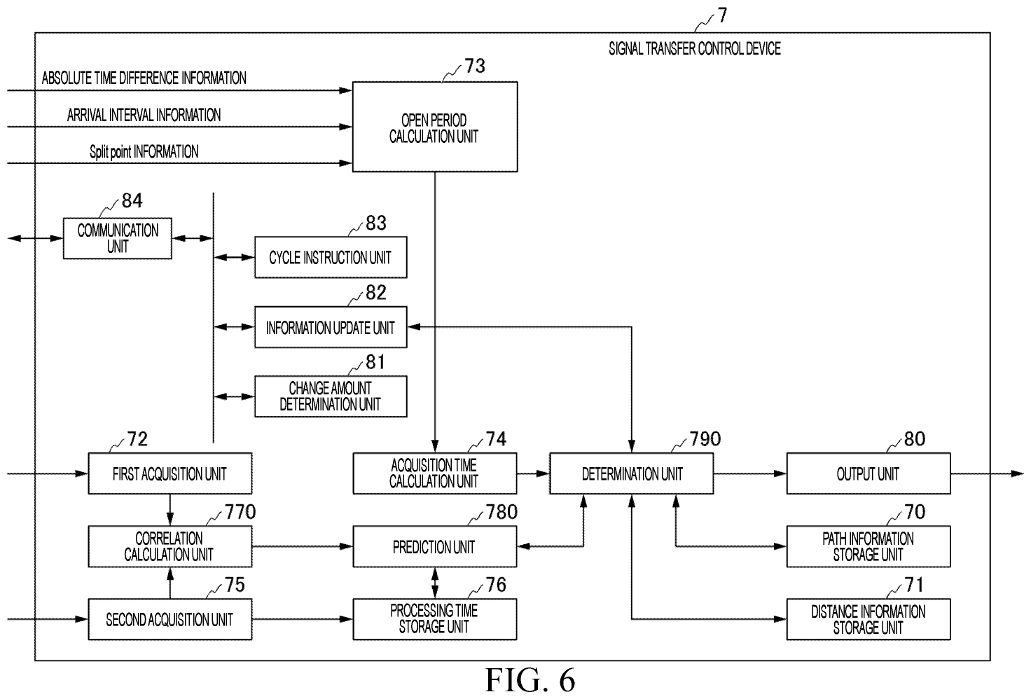

FIG. 6 illustrates a configuration example of the signal transfer control device 7 according to the third embodiment. The signal transfer control device 7 includes a path information storage unit 70, a distance information storage unit 71, a first acquisition unit 72, an open period calculation unit 73, an acquisition time calculation unit 74, a second acquisition unit 75, a processing time storage unit 76, a correlation calculation unit 770, a prediction unit 780, a determination unit 790, an output unit 80, a change amount determination unit 81, an information update unit 82, a cycle instruction unit 83, and a communication unit 84.

The change amount determination unit 81 acquires first schedule information as cooperation information from the first acquisition unit 72 or the communication unit 84. The cooperation information is information used for cooperation of each piece of schedule information of the connected network.

The cooperation information may include, for example, information defined in at least one of “open radio access network (O-RAN) cooperative transport interface (CTI)”, “ITU-T G. 989.3 Amd 3. G. sul 66”, “third generation partnership project (3GPP) TS 28.552”, “3GPP TS 38.300”, “3GPP TS 23.502 4.2.2”, “3GPP TS 38.401”, and “3GPP TS 23.401 5.3.2”.

For example, the cooperation information includes schedule information (O-RAN CTI) (ITU-T G. 989.3 Amd 3.G.sul 66) as information (bandwidth information) regarding the traffic volume. The schedule information may be, for example, downlink control information (DCI). For example, the cooperation information may include average throughput information as information regarding the traffic volume.

For example, the cooperation information may include information “UE active number” (3GPP TS 28.552) regarding the number of wireless terminals (not illustrated) connected in the cell. For example, the cooperation information may include “Registration information” (UE registration) (3GPP TS 23.502 4.2.2, TS 38.401) as information regarding the number of wireless terminals (not illustrated) connected to each distributed unit 10.

The change amount determination unit 81 of a signal transfer control device 7-1 derives a change amount of traffic in the distributed unit 10 on the basis of the cooperation information acquired from the distributed unit 10. The change amount determination unit 81 of a signal transfer control device 7-2 may derive the change amount of traffic in a signal transfer device 5-2 on the basis of the cooperation information acquired from the signal transfer control device 7-1.

The change amount determination unit 81 compares the change amount of traffic with a predetermined threshold “a”. The change amount determination unit 81 outputs the comparison result to the cycle instruction unit 83.

When a trigger signal is acquired by the communication unit 84, the information update unit 82 of the signal transfer control device 7-2 updates the second schedule information on the basis of the cooperation information. The information update unit 82 may transmit the second schedule information as the first schedule information to another signal transfer control device 7 via the communication unit 84.

Note that the information update unit 82 may acquire the second schedule information from the determination unit 790. The information update unit 82 may transmit the second schedule information as the first schedule information to another signal transfer control device 7 via the communication unit 84. The information update unit 82 may output the trigger signal to the determination unit 790. The determination unit 790 may generate the second schedule information in a case where the trigger signal is input from the information update unit 82.

When the change amount of traffic is less than the predetermined threshold “a”, the cycle instruction unit 83 transmits, to the communication unit 84, an instruction of a notification cycle indicating a predetermined first cycle (for example, 1 ms). When the change amount of traffic is equal to or greater than the predetermined threshold “a”, the cycle instruction unit 83 transmits, to the communication unit 84, an instruction of a notification cycle indicating a predetermined second cycle (for example, 125 μs).

The communication unit 84 performs communication with another connected signal transfer control device 7. The communication unit 84 transmits the instruction of the notification cycle determined by the cycle instruction unit 83 to the other signal transfer control device 7 connected to the communication unit 84. The instruction of the notification cycle is, for example, an instruction of the notification cycle of the first schedule information.

The communication unit 84 acquires the cooperation information from the other signal transfer control device 7 connected to the communication unit 84. The communication unit 84 acquires the trigger signal from the other signal transfer control device 7 connected to the communication unit 84. The communication unit 84 may acquire the cooperation information from the distributed unit 10 connected to the communication unit 84. The communication unit 84 transmits the schedule information to the other signal transfer control device 7 at a cycle instructed by the instruction of the notification cycle.

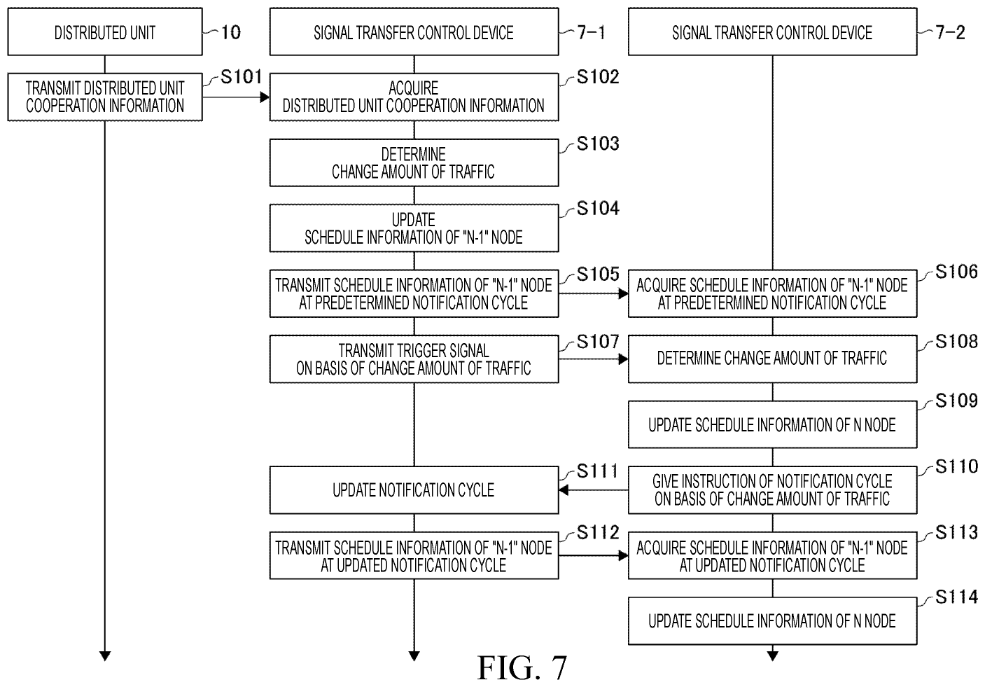

FIG. 7 is a sequence diagram of an operation example of the signal transfer control device 7 according to the third embodiment. The distributed unit 10 transmits the cooperation information (hereinafter referred to as “distributed unit cooperation information”) in the distributed unit 10 to the signal transfer control device 7-1 (step S101). The signal transfer control device 7-1 acquires the distributed unit cooperation information (step S102).

The signal transfer control device 7-1 (“N−1” node) determines a change amount (variation amount) of traffic. For example, the signal transfer control device 7-1 compares the change amount of traffic of the distributed unit 10 with the magnitude of the threshold “α” (step S103) When the change amount of traffic is equal to or greater than the threshold “α”, the signal transfer control device 7-1 updates the second schedule information in the “N−1” node. The signal transfer control device 7-1 may update the cooperation information in the “N−1” node (step S104).

For example, when the change amount of traffic of the distributed unit 10 is less than the threshold “a”, the signal transfer control device 7-1 transmits the updated second schedule information in the “N−1” node to the signal transfer control device 7-2 (N node) at a predetermined notification cycle (for example, 1 ms cycle). The signal transfer control device 7-1 may transmit the updated cooperation information in the “N−1” node to the signal transfer control device 7-2 at a similar notification cycle (step S105).

The signal transfer control device 7-2 acquires the updated second schedule information in the signal transfer control device 7-1 (“N−1” node) from the signal transfer control device 7-1 at a predetermined notification cycle (for example, 1 ms cycle) as the first schedule information for the signal transfer control device 7-2. The signal transfer control device 7-2 may acquire the updated cooperation information in the “N−1” node from the signal transfer control device 7-1 at a similar notification cycle (step S106).

For example, when the change amount of traffic of the distributed unit 10 is equal to or greater than the threshold “α”, the signal transfer control device 7-1 transmits a trigger signal to the signal transfer control device 7-2 (N node) (step S107).

When acquiring the trigger signal, the signal transfer control device 7-2 determines the change amount of traffic. For example, the signal transfer control device 7-2 determines the change amount of traffic of the signal transfer device 5-2 or the central office 4a (step S108). The signal transfer control device 7-2 updates the second schedule information in the signal transfer control device 7-2 (N node) (step S109).

For example, when the change amount of traffic of the signal transfer device 5-2 or the central office 4a is equal to or greater than the threshold “α”, the signal transfer control device 7-2 transmits an instruction of a notification cycle indicating a cycle (for example, 125 μs cycle) shorter than the notification cycle in step S105 to the signal transfer control device 7-1 (step S110).

Note that when the change amount of traffic per unit time is equal to or greater than the threshold “α”, the signal transfer control device 7 may derive a bandwidth (prediction result) necessary in the future by multiplying the number of connections of wireless terminals (not illustrated) for each distributed unit 10 by the traffic volume. The signal transfer control device 7, on the basis of the prediction result,

The signal transfer control device 7-1 updates the cycle at which the signal transfer control device 7-1 notifies the signal transfer control device 7-2 of the second schedule information in the “N−1” node as the first schedule information to the instructed notification cycle (step S111). The signal transfer control device 7-1 transmits the second schedule information in the “N−1” node as the first schedule information to the signal transfer control device 7-2 at the updated notification cycle (for example, 125 μs cycle) (step S112).

The signal transfer control device 7-2 acquires the second schedule information in the “N−1” node as the first schedule information from the signal transfer control device 7-1 at the updated notification cycle (for example, 125 μs cycle) (step S113). The signal transfer control device 7-2 determines the change amount of traffic (step S114). The signal transfer control device 7-2 updates the second schedule information in the N node (step S115).

As described above, the signal transfer system 1a includes the signal transfer control device 7-1 (first signal transfer control device) associated with a first network and the signal transfer control device 7-2 (second signal transfer control device) associated with a second network connected to the first network via the central office 4a (intermediate node). The signal transfer control device 7-1 includes the communication unit 84 (first communication unit) (second communication unit) of the signal transfer control device 7-1. The communication unit 84 of the signal transfer control device 7-1 transmits first schedule information indicating a schedule of signal transfer in the first network at a predetermined notification cycle. The communication unit 84 of the signal transfer control device 7-1 transmits a trigger signal on the basis of the change amount of traffic of the first network. The signal transfer control device 7-2 includes the first acquisition unit 72 (acquisition unit), the communication unit 84 (third communication unit) of the signal transfer control device 7-2, the change amount determination unit 81, the information update unit 82, and the cycle instruction unit 83. The first acquisition unit 72 (acquisition unit) acquires the first schedule information at a predetermined notification cycle. The communication unit 84 (third communication unit) of the signal transfer control device 7-2 acquires the trigger signal from the communication unit 84 of the signal transfer control device 7-1. When the trigger signal is acquired, the change amount determination unit 81 determines whether or not the change amount of traffic of the first network is equal to or greater than the threshold “α” on the basis of the first schedule information. When it is determined that the change amount is equal to or greater than the threshold, the information update unit 82 updates the second schedule information indicating the schedule of signal transfer in the second network. When it is determined that the change amount is equal to or greater than the threshold, the cycle instruction unit 83 instructs the signal transfer control device 7-1 to set a predetermined notification cycle.

For example, in the signal transfer control device 7-2, the first acquisition unit 72 acquires the first schedule information from the signal transfer control device 7-1 at a predetermined notification cycle. The communication unit 84 acquires the trigger signal based on the change amount of traffic of the first network from the signal transfer control device 7-1. When the trigger signal is acquired, the change amount determination unit 81 determines whether or not the change amount of traffic of the first network is equal to or greater than the threshold on the basis of the first schedule information. When it is determined that the change amount is equal to or greater than the threshold, the information update unit 82 updates the second schedule information. When it is determined that the change amount is equal to or greater than the threshold, the cycle instruction unit 83 instructs the signal transfer control device 7-1 to set a predetermined notification cycle.

As described above, in the third embodiment, it is possible to curb an increase in the load of at least one of the reception processing and the calculation processing in the signal transfer control device 7.

Some or all of the functions of the signal transfer control devices 7-1 and 7-2, the central office 4a, and the signal transfer device 5 may be configured by hardware such as a programmable logic device (PLD) or a field programmable gate array (FPGA) or may be configured as a program executed by a processor such as a CPU.

For example, the signal transfer control device 7 according to an embodiment can be implemented by using a computer and a program and can record the program in a storage medium or can provide the program via a network.

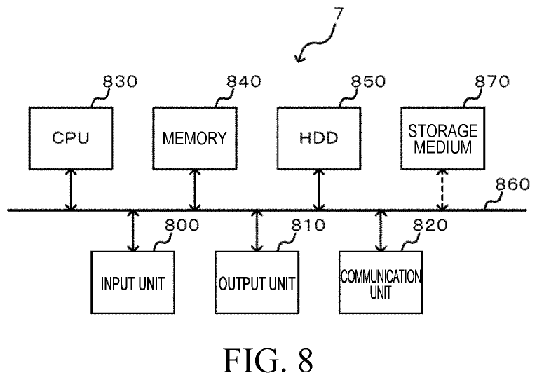

FIG. 8 illustrates a hardware configuration example of the signal transfer control device 7 according to the embodiments. As illustrated in FIG. 8, for example, the signal transfer control device 7 has a function as a computer in which an input unit 800, an output unit 810, a communication unit 820, a CPU 830, a memory 840, and an HDD 850 are connected via a bus 860. The signal transfer control device 7 can input and output data to and from a computer-readable storage medium 870.

The input unit 800 is, for example, a keyboard, a mouse, or the like. The output unit 810 is, for example, a display device such as a display. The communication unit 820 is, for example, a network interface or the like.

The CPU 830 controls each unit included in the signal transfer control device 7 and performs predetermined processing and the like. The memory 840 and the HDD 850 are storage units that store data and the like.

The storage medium 870 can store a program or the like for executing the functions of the signal transfer control device 7. Note that the architecture forming the signal transfer control device 7 is not limited to the example of FIG. 8.

The following supplementary notes are disclosed regarding the signal transfer control device described in the first embodiment.

### Supplementary Note A1

A signal transfer control device that controls a signal transfer schedule of a signal transfer system that transfers a signal via an intermediate node from a first network in which a plurality of signal transfer devices transfers a signal to a second network in which a plurality of signal transfer devices transfers a signal, the signal transfer control device comprising:
a first acquisition unit that acquires first schedule information indicating a schedule in which the signal transfer device that finally transfers a signal to the intermediate node in the first network transfers a signal;
a second acquisition unit that acquires processing time information indicating a time required for processing performed by the intermediate node to transfer the signal transferred from the first network to the second network;
a determination unit that determines second schedule information indicating a schedule in which the signal transfer device that first transfers the signal transferred by the intermediate node in the second network is to transfer the signal on the basis of the first schedule information acquired by the first acquisition unit and the processing time information acquired by the second acquisition unit; and
an output unit that outputs the second schedule information determined by the determination unit to the signal transfer device that first transfers the signal transferred by the intermediate node in the second network.

### Supplementary Note A2

The signal transfer control device according to Supplementary note A1, wherein the determination unit determines the second schedule information by synchronizing a time between the first network and the second network.

### Supplementary Note A3

The signal transfer control device according to Supplementary note A2, wherein
the first acquisition unit acquires the first schedule information at a predetermined periodic first timing,
the second acquisition unit acquires the processing time information at a predetermined periodic second timing different from the first timing, and
the determination unit determines the second schedule information on the basis of a result of determining whether or not a time between a time at which the first acquisition unit acquires the first schedule information and a time at which the second acquisition unit acquires the processing time information is longer than the time indicated by the processing time information acquired by the second acquisition unit.

### Supplementary Note A4

The signal transfer control device according to any one of Supplementary notes A1 to A3, wherein the determination unit determines the second schedule information on the basis of a bandwidth in which the signal in the second network is transferable.

### Supplementary Note A5

A signal transfer control method of controlling a signal transfer schedule of a signal transfer system that transfers a signal via an intermediate node from a first network in which a plurality of signal transfer devices transfers a signal to a second network in which a plurality of signal transfer devices transfers a signal, the signal transfer control method comprising:
a first acquisition step of acquiring first schedule information indicating a schedule in which the signal transfer device that finally transfers a signal to the intermediate node in the first network transfers a signal;
a second acquisition step of acquiring processing time information indicating a time required for processing performed by the intermediate node to transfer the signal transferred from the first network to the second network;
a determination step of determining second schedule information indicating a schedule in which the signal transfer device that first transfers the signal transferred by the intermediate node in the second network is to transfer the signal on the basis of the first schedule information and the processing time information; and
an output step of outputting the determined second schedule information to the signal transfer device that first transfers the signal transferred by the intermediate node in the second network.

### Supplementary Note A6

A signal transfer control program for causing a computer to function as each unit of the signal transfer control device according to any one of Supplementary notes A1 to A4.

### Supplementary Note A7

A signal transfer system comprising:
a first network in which a plurality of signal transfer devices transfers a signal;
a second network in which a plurality of signal transfer devices transfers a signal;
an intermediate node that transfers a signal from the first network to the second network; and
a signal transfer control device that controls a signal transfer schedule for transferring a signal from the intermediate node to the second network,
wherein the signal transfer control device includes
a first acquisition unit that acquires first schedule information indicating a schedule in which the signal transfer device that finally transfers a signal to the intermediate node in the first network transfers a signal,
a second acquisition unit that acquires processing time information indicating a time required for processing performed by the intermediate node to transfer the signal transferred from the first network to the second network,
a determination unit that determines second schedule information indicating a schedule in which the signal transfer device that first transfers the signal transferred by the intermediate node in the second network is to transfer the signal on the basis of the first schedule information acquired by the first acquisition unit and the processing time information acquired by the second acquisition unit, and
an output unit that outputs the second schedule information determined by the determination unit to the signal transfer device that first transfers the signal transferred by the intermediate node in the second network.

### Supplementary Note A8

The signal transfer system according to Supplementary note A7, wherein the determination unit determines the second schedule information by synchronizing a time between the first network and the second network.

The following supplementary notes are disclosed regarding the signal transfer control device described in the second embodiment.

### Supplementary Note B1

A signal transfer control device that controls a signal transfer schedule of a signal transfer system that transfers a signal via an intermediate node from a first network in which a plurality of signal transfer devices transfers a signal to a second network in which a plurality of signal transfer devices transfers a signal, the signal transfer control device comprising:
a first acquisition unit that acquires first schedule information indicating a schedule in which the signal transfer device that finally transfers a signal to the intermediate node in the first network transfers a signal;
a second acquisition unit that acquires, for each signal transferred from the first network, processing time information indicating a time required for processing performed by the intermediate node to transfer the signal to the second network;
a correlation calculation unit that calculates a correlation between a traffic volume flowing into the intermediate node and a time required for signal transfer processing on the basis of the first schedule information acquired by the first acquisition unit and a plurality of pieces of the processing time information acquired for each signal by the second acquisition unit;
a prediction unit that predicts a time required for signal transfer according to the traffic volume in the intermediate node on the basis of the correlation calculated by the correlation calculation unit and the processing time information acquired for each signal by the second acquisition unit;
a determination unit that determines second schedule information indicating a schedule in which the signal transfer device that first transfers the signal transferred by the intermediate node in the second network is to transfer the signal on the basis of the first schedule information acquired by the first acquisition unit and the time predicted by the prediction unit; and
an output unit that outputs the second schedule information determined by the determination unit to the signal transfer device that first transfers the signal transferred by the intermediate node in the second network.

### Supplementary Note B2

The signal transfer control device according to Supplementary note B1, wherein the determination unit determines the second schedule information by synchronizing a time between the first network and the second network.

### Supplementary Note B3

The signal transfer control device according to Supplementary note B2, wherein
the first acquisition unit acquires the first schedule information at a predetermined periodic first timing,
the second acquisition unit acquires the processing time information at a predetermined periodic second timing different from the first timing, and
the determination unit determines the second schedule information on the basis of a result of determining whether or not a time between a time at which the first acquisition unit acquires the first schedule information and a time at which the second acquisition unit acquires the processing time information is longer than the time indicated by the processing time information acquired by the second acquisition unit.

### Supplementary Note B4

The signal transfer control device according to any one of Supplementary notes B1 to B3, wherein the determination unit determines the second schedule information on the basis of a bandwidth in which the signal in the second network is transferable.

### Supplementary Note B5

A signal transfer control method of controlling a signal transfer schedule of a signal transfer system that transfers a signal via an intermediate node from a first network in which a plurality of signal transfer devices transfers a signal to a second network in which a plurality of signal transfer devices transfers a signal, the signal transfer control method comprising:
a first acquisition step of acquiring first schedule information indicating a schedule in which the signal transfer device that finally transfers a signal to the intermediate node in the first network transfers a signal;
a second acquisition step of acquiring, for each signal transferred from the first network, processing time information indicating a time required for processing performed by the intermediate node to transfer the signal to the second network;
a correlation calculation step of calculating a correlation between a traffic volume flowing into the intermediate node and a time required for signal transfer processing on the basis of the first schedule information acquired in the first acquisition step and a plurality of pieces of the processing time information acquired for each signal in the second acquisition step;
a prediction step of predicting a time required for signal transfer according to the traffic volume in the intermediate node on the basis of the calculated correlation and the processing time information acquired for each signal;
a determination step of determining second schedule information indicating a schedule in which the signal transfer device that first transfers the signal transferred by the intermediate node in the second network is to transfer the signal on the basis of the first schedule information acquired in the first acquisition step and the time predicted in the prediction step; and
an output step of outputting the determined second schedule information to the signal transfer device that first transfers the signal transferred by the intermediate node in the second network.

### Supplementary Note B6

A signal transfer control program for causing a computer to function as each unit of the signal transfer control device according to any one of Supplementary notes B1 to B4.

### Supplementary Note B7

A signal transfer system comprising:
a first network in which a plurality of signal transfer devices transfers a signal;
a second network in which a plurality of signal transfer devices transfers a signal;
an intermediate node that transfers a signal from the first network to the second network; and
a signal transfer control device that controls a signal transfer schedule for transferring a signal from the intermediate node to the second network,
wherein the signal transfer control device includes
a first acquisition unit that acquires first schedule information indicating a schedule in which the signal transfer device that finally transfers a signal to the intermediate node in the first network transfers a signal,
a second acquisition unit that acquires, for each signal transferred from the first network, processing time information indicating a time required for processing performed by the intermediate node to transfer the signal to the second network,
a correlation calculation unit that calculates a correlation between a traffic volume flowing into the intermediate node and a time required for signal transfer processing on the basis of the first schedule information acquired by the first acquisition unit and a plurality of pieces of the processing time information acquired for each signal by the second acquisition unit,
a prediction unit that predicts a time required for signal transfer according to the traffic volume in the intermediate node on the basis of the correlation calculated by the correlation calculation unit and the processing time information acquired for each signal by the second acquisition unit,
a determination unit that determines second schedule information indicating a schedule in which the signal transfer device that first transfers the signal transferred by the intermediate node in the second network is to transfer the signal on the basis of the first schedule information acquired by the first acquisition unit and the time predicted by the prediction unit, and
an output unit that outputs the second schedule information determined by the determination unit to the signal transfer device that first transfers the signal transferred by the intermediate node in the second network.

### Supplementary Note B8

The signal transfer system according to Supplementary note B7, wherein the determination unit determines the second schedule information by synchronizing a time between the first network and the second network.

### INDUSTRIAL APPLICABILITY

The present invention can be applied to optical communication systems such as an optical access system.

### REFERENCE SIGNS LIST

1, 1a Signal transfer system
2, 2a First network
3, 3a Second network
4, 4a Central office
5-1 to 5-8 Signal transfer device
6-1, 6-2 Signal transfer control device
7-1, 7-2 Signal transfer control device
10-1, 10-2 Distributed unit
12 Host device
50 Receiving unit
51 Signal distribution unit
52 Buffer unit
53 Time gate unit
54 Control unit
55 Transmission unit
70 Path information storage unit
71 Distance information storage unit
72 First acquisition unit
73 Open period calculation unit
74 Acquisition time calculation unit
75 Second acquisition unit
76 Processing time storage unit
77 Time acquisition unit
78 Determination unit
79 Output unit
80 Output unit
81 Change amount determination unit
82 Information update unit
83 Cycle instruction unit
84 Communication unit
520 Buffer
530 Gate
770 Correlation calculation unit
780 Prediction unit
790 Determination unit
800 Input unit
810 Output unit
820 Communication unit
830 CPU
840 Memory
850 HDD
860 Bus
870 Storage medium

1. A signal transfer system comprising:
a first signal transfer control device associated with a first network; and
a second signal transfer control device associated with a second network connected to the first network via an intermediate node,
wherein
the first signal transfer control device includes
a first communicator that transmits first schedule information indicating a schedule of signal transfer in the first network at a predetermined notification cycle, and
a second communicator that transmits a trigger signal on the basis of a change amount of traffic of the first network, and
the second signal transfer control device includes
an acquisitor that acquires the first schedule information at the predetermined notification cycle,
a third communicator that acquires the trigger signal from the second communicator,
a change amount determiner that, when the trigger signal is acquired, determines whether or not the change amount of traffic of the first network is equal to or greater than a threshold on the basis of the first schedule information,
an information updater that updates second schedule information indicating a schedule of signal transfer in the second network when it is determined that the change amount is equal to or greater than the threshold, and
a cycle instructor that instructs the first signal transfer control device to set the predetermined notification cycle when it is determined that the change amount is equal to or greater than the threshold.

2. A signal transfer control device comprising:
an acquisitor that acquires first schedule information indicating a schedule of signal transfer in a first network from another signal transfer control device associated with the first network at a predetermined notification cycle;
a communicator that acquires a trigger signal based on a change amount of traffic of the first network from the other signal transfer control device;
a change amount determiner that, when the trigger signal is acquired, determines whether or not the change amount of traffic of the first network is equal to or greater than a threshold on the basis of the first schedule information;
an information updater that updates second schedule information indicating a schedule of signal transfer in a second network connected to the first network via an intermediate node when it is determined that the change amount is equal to or greater than the threshold; and
a cycle instructor that instructs the other signal transfer control device to set the predetermined notification cycle when it is determined that the change amount is equal to or greater than the threshold.

3. A signal transfer control method executed by a signal transfer control device, the method comprising:
acquiring first schedule information indicating a schedule of signal transfer in a first network from another signal transfer control device associated with the first network at a predetermined notification cycle;
acquiring a trigger signal based on a change amount of traffic of the first network from the other signal transfer control device;
when the trigger signal is acquired, determining whether or not the change amount of traffic of the first network is equal to or greater than a threshold on the basis of the first schedule information;
updating second schedule information indicating a schedule of signal transfer in a second network connected to the first network via an intermediate node when it is determined that the change amount is equal to or greater than the threshold; and
instructing the other signal transfer control device to set the predetermined notification cycle when it is determined that the change amount is equal to or greater than the threshold.

4. A non-transitory computer readable medium which stores a program for causing a computer to function as the signal transfer control device according to claim 2.
